(19) United States
(12) Patent Application Publication
(10) Pub. No.: US 2007/0046648 A1
(43) Pub. Date: Mar. 1, 2007

(54) Touch sensor having compensated base capacitance

(76) Inventors: Wen-Kai Lee, Kaohsiung City (TW); Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/510,817

(22) Filed: Aug. 28, 2006

(30) Foreign Application Priority Data
Aug. 31, 2005 (TW) 094129799

(51) Int. Cl. G09G 5/00

(52) U.S. Cl. 345/173

(57) ABSTRACT

A touch sensor comprises a plurality of traces in a same sensing layer or in different sensing layers, and the base capacitances of the traces are made uniform by connecting one or more compensation areas to one or more of the traces or selecting the distances between the grounding layer and one or more of the traces. The compensation area and the trace it compensates may or may not in a same layer.

### FIELD OF THE INVENTION

The present invention is related generally to a touchpad and, more particularly, to a touch sensor of a touchpad.

### BACKGROUND OF THE INVENTION

Touchpad has been widely used in various electronic products, for example notebook computer, personal digital assistant (PDA), mobile phone and other electronic systems. Touchpad serves as an input device where users could touch or slide on the panel of the touchpad by an object, for example finger or fingers, to control the cursor on a window in relative movement or absolute coordinate movement to support various input functions such as text writing, window scrolling and button pressing. Conventionally, the touch sensor of a touchpad has symmetrical structure such as the square shape shown in FIG. 1. The traces of the sensor all have a same shape and area, and thus the base capacitances of the traces are symmetrically distributed across the sensor. The sensed capacitive measures caused by an object touching on the sensor are also symmetrical and linear across the sensor as shown in FIG. 2. However, the shape and structure of the touch sensor would be changed with different applications and produces asymmetrical sensing characteristics accordingly. An asymmetrical sensor refers to the one including at least one of the features of the sensor, such as the shape of the sensor, the thickness of each layer in the sensor, the area of the traces, and the distances between the traces to the grounding layer, that is asymmetrical. In a touch sensor, the base capacitance of a trace is proportional to the area of the trace and the inverse of the distance between the trace and the grounding layer, or simply represented as
C=∈×(A/d) (Eq-1)
where C is the base capacitance of the trace, ∈ is the dielectric constant, A is the area of the trace, and d is the distance between the trace and the grounding layer. The sensed capacitive measure of the trace caused by an object is
S∝(ΔC/C) (Eq-2)
where ΔC is the differential capacitance of the trace caused by the object. Therefore, the area of the trace and the distance between the trace and the grounding layer both are factors of determining the base capacitance of the trace. For example, in a circular touch sensor 100 shown in FIG. 3, the traces X0 to X6 along the horizontal direction have different lengths and different areas. From the equation Eq-1 it is conducted that, if all the traces of a touch sensor are spaced from a grounding layer with a same distance, the trace having greater area will have greater base capacitance. Accordingly, the base capacitances of the traces are asymmetrically distributed across the sensor 100. As illustrated by the equation Eq-2, when an object operating on the sensor 100, the sensed capacitive measure S will vary with position across the sensor 100, as shown in FIG. 4, since the traces of the sensor 100 have different base capacitances. The asymmetricity and nonlinearity of the sensed capacitive measure S will cause the touchpad having errorous judgment to an operation or undesired offset in the judged position to a touch of an object operating thereon.

Therefore, it is desired a touch sensor having uniform base capacitances between the traces thereof.

### SUMMARY OF THE INVENTION

Accordingly, an object of the present invention is to provide a touch sensor having uniform base capacitances between the traces thereof.

In an embodiment according to the present invention, a touch sensor comprises a compensation area electrically connected to one of two traces such that the two traces will have equivalent base capacitances.

Alternatively, a touch sensor according to the present invention comprises two compensation areas electrically connected to two traces, respectively, such that the two traces will have equivalent base capacitances.

More generally, a touch sensor according to the present invention comprises two traces provided by two sensing layers, and the area difference between the two traces and the distance difference between the two sensing layers from a grounding layer are so selected that the two traces will have equivalent base capacitances.

In a touchpad according to the present invention, with one or more compensation areas or the distance difference between traces from a grounding layer for the touch sensor, the traces on a same sensing layer or on different sensing layers could have equivalent base capacitances, and therefore, the problems caused by the asymmetricity and nonlinearity of the touch sensor are solved and the touchpad is improved accordingly.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a top view of a square touch sensor;

FIG. 2 shows a relationship of the sensed capacitive measure caused by an object with the position across the touch sensor of FIG. 1;

FIG. 3 shows a top view of a circular touch sensor;

FIG. 4 shows a relationship of the sensed capacitive measure caused by an object with the position across the touch sensor of FIG. 3;

FIG. 5 shows a first embodiment of the present invention;

FIG. 6 shows a second embodiment of the present invention;

FIG. 7 shows a cross-sectional view of the sensing layers in a first embodiment of the touch sensor shown in FIG. 6;

FIG. 8 shows a cross-sectional view of the sensing layers in a second embodiment of the touch sensor shown in FIG. 6; and

FIG. 9 shows a cross-sectional view of the sensing layers in a third embodiment of the touch sensor shown in FIG. 6.

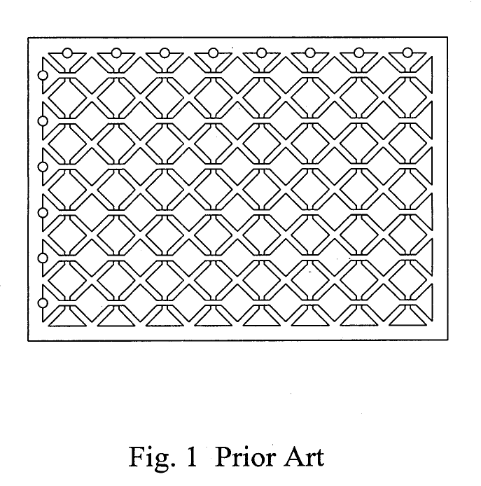

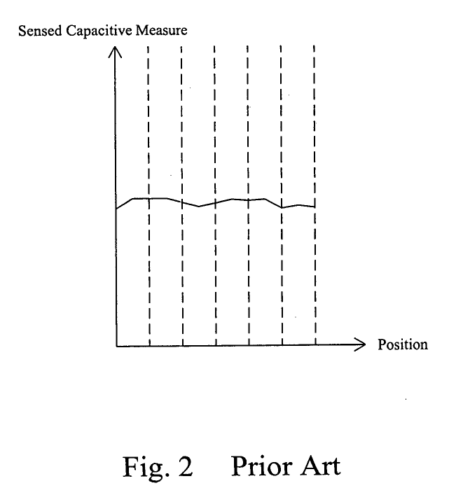

### DETAILED DESCRIPTION OF THE INVENTION

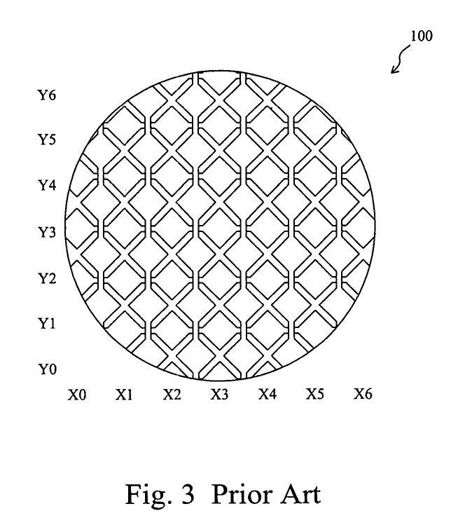

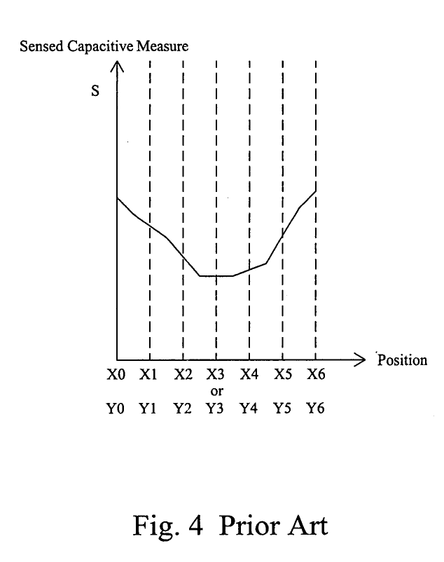

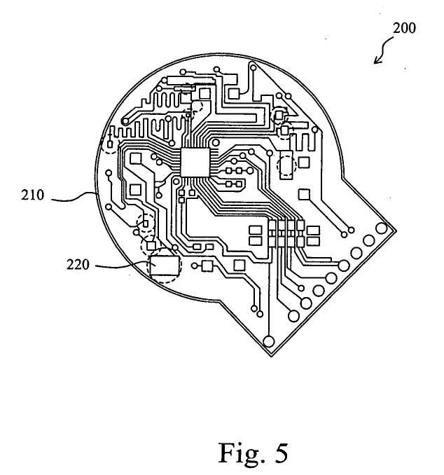

FIG. 5 shows a first embodiment of the present invention, which provides a compensation structure 200 for the circular touch sensor 100 shown in FIG. 3. In this structure, FIG. 3 shows the traces in the sensing layers seen from the topside of printed circuit board, and FIG. 5 shows the device layer 210 on the bottom side of the printed circuit board. In the touch sensor 100, the traces X0 to X6 along the horizontal direction and the traces Y0 to Y6 along the vertical direction are perpendicular to each other, and a compensation area 220 is provided on the device layer 210 to electrically connect to one or more of the traces in the sensing layer through via in the printed circuit board. The compensation area 220 is electrically conductive, for example made of a portion of the copper foil in the device layer 210, and provides compensating capacitance for the trace to be compensated in base capacitance. The size of the compensation area 220 is determined based on the capacitance difference between the trace to be compensated and the trace without compensation, and it could be calculated with the area difference between the two traces and the distance difference from the grounding layer by use of the equation Eq-1. For example, in the case that the trace X0 is to be compensated to have the equivalent base capacitance to that of the trace X3, the traces X0 and X3 have an area difference A1, and both the traces X0 and X3 are in a same sensing layer spaced from the grounding layer with a distance d1, the capacitance difference between the traces X0 and X3 is ∈×(A1/d1). If the compensation area 220 has a size A2 and the device layer 210 is spaced from the grounding layer with a distance d2, then the compensation capacitance provided by the compensation area 220 is ∈×(A2/d2). Let ∈×(A1/d1)=∈×(A2/d2), it is obtained A2=A1×(d2/d1). With the compensation area 220 electrically connected to the trace X0, the traces X0 and X3 will have equivalent base capacitances. By compensating to all the other traces in this way, the traces of the touch sensor 100 will have uniform and linear base capacitances and thus the sensed capacitive measures in response to the object operating on the touch sensor 100 become symmetrical and linear. In another embodiment, a target value is selected for the base capacitances of all the traces of the touch sensor 100. In this circumstance, the equation Eq-1 is used to calculate the compensation area for each trace, and each trace is compensated to its base capacitance by a respective compensation area, such that all the traces will have the uniform base capacitance, i.e., the target value. In some embodiments, the compensation area and the compensated trace both are in a same sensing layer. Yet in some other embodiments, some compensation areas are in one layer, for example the sensing layer including the compensated traces, and some other compensation areas are in another layer, for example the device layer.

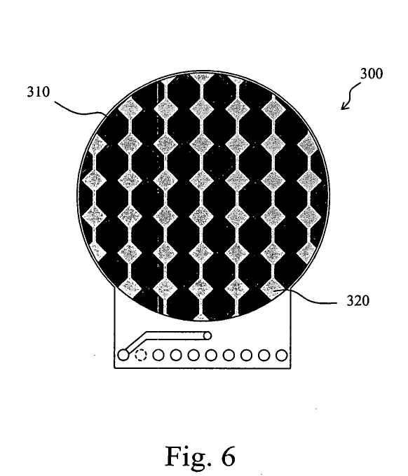

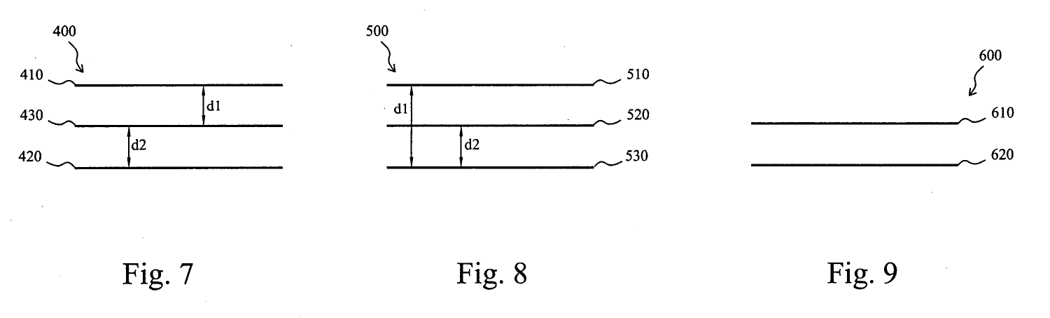

FIG. 6 shows a top view of another embodiment according to the present invention, in which a circular touch sensor 300 comprises several traces 310 in a first sensing layer, several traces 320 in a second sensing layer, and the directions of the traces 310 and 320 are perpendicular to each other. However, two factors, the area and the distance from the grounding layer, are used in this design to compensate the traces 310 and traces 320 such that their base capacitances will be uniform. In one embodiment, A1 represents the area of one trace 310, d1 represents the distance between the trace 310 and the grounding layer, A2 represents the area of one trace 320, and d2 represents the distance between the trace 320 and the grounding layer. According to the equation Eq-1, the base capacitance of the trace 310 is ∈×(A1/d1), and the base capacitance of the trace 320 is ∈×(A2/d2). Let ∈×(A1/d1)=∈×(A2/d2), it is obtained the relationship A1/A2=d1/d2 between the traces 310 and 320. In circumstances that the distance d1 from the trace 310 to the grounding layer is not equal to the distance d2 from the trace 320 to the grounding layer, then the trace closer to the grounding layer would have a smaller area than the other one. The grounding layer may or may not be between the first and second sensing layers. In one embodiment as shown in FIG. 7, which shows a cross-sectional view of a sensor structure 400, the grounding layer 430 is located between the sensing layers 410 and 420. The trace 310 is in the sensing layer 410, the trace 320 is in the sensing layer 420, the distance from the grounding layer 430 to the sensing layer 410 is d1, and the distance from the grounding layer 430 to the sensing layer 420 is d2. In an embodiment, the areas of the traces 310 and 320 are the same and the distance d1 is equal to the distance d2, so that the base capacitances of the traces 310 and 320 are the same. In another embodiment, the areas of the traces 310 and 320 are different and the distances d1 and d2 are also different, in order that the traces 310 and 320 have a same base capacitance. In another embodiment as shown in FIG. 8, which shows a cross-sectional view of a sensor structure 500, the grounding layer 530 is not located between the sensing layers 510 and 520. The trace 310 is in the sensing layer 510, the trace 320 is in the sensing layer 520, the distance d1 between the grounding layer 530 and the sensing layer 510 is greater than the distance d2 between the grounding layer 530 and the sensing layer 520, and the area of the trace 310 is greater than the area of the trace 320, in order that the base capacitances of the traces 310 and 320 are equal to each other. In yet another embodiment as shown in FIG. 9, which shows a cross-sectional view of a sensor structure 600, the trace 310 is in a sensing layer 610, the trace 320 is in another sensing layer 620, and there is no grounding layer in the touch sensor 300. In this structure, the grounding layer may be referred infinitely far away.

In different embodiments, the structures illustrated in the above embodiments may be combined in one touch sensor, such that the traces on the same and different layers have symmetrical and liner distribution of base capacitances across the touch sensor, and thereby the sensed capacitive measures caused by an object operating on the sensor will be symmetrical and liner across the touch sensor.

1. A touch sensor comprising:
a first trace having a first area;
a second trace having a second area; and
a compensation area electrically connected to the second trace such that the first and second traces have a same base capacitance.

2. The touch sensor of claim 1, wherein the compensation area is in a device layer.

3. The touch sensor of claim 1, wherein the compensation area and the second trace both are in a same sensing layer.

4. The touch sensor of claim 1, wherein the first and second traces both are in a same sensing layer.

5. The touch sensor of claim 1, wherein the first and second traces are in two sensing layers, respectively.

6. The touch sensor of claim 1, wherein the first and second traces are perpendicular to each other.

7. A touch sensor comprising:
a first trace having a first area;
a second trace having a second area; and
a first compensation area and a second compensation area electrically connected to the first and second traces, respectively, such that the first and second traces have a same base capacitance.

8. The touch sensor of claim 7, wherein at least one of the first and second compensation areas is in a device layer.

9. The touch sensor of claim 7, wherein the first compensation area and the first trace both are in a same sensing layer.

10. The touch sensor of claim 7, wherein the first and second traces both are in a same sensing layer.

11. The touch sensor of claim 7, wherein the first and second traces are in two sensing layers, respectively.

12. The touch sensor of claim 7, wherein the first and second traces are perpendicular to each other.

13. A touch sensor comprising:
a first trace in a first sensing layer; and
a second trace in a second sensing layer;
wherein the first and second traces have a same base capacitance.

14. The touch sensor of claim 13, wherein the first and second traces are perpendicular to each other.

15. The touch sensor of claim 13, wherein the first and second traces have different areas.

16. The touch sensor of claim 15, further comprising a grounding layer spaced from the first and second traces with a first distance and a second distance, respectively, the first and second distances being not equal.

17. The touch sensor of claim 16, wherein the grounding layer is between the first and second sensing layers.

18. The touch sensor of claim 16, wherein the grounding layer is not between the first and second sensing layers.

19. (canceled)

20. The touch sensor of claim 13, further comprising a grounding layer between the first and second sensing layers with a same distance to the first and second sensing layers, the first and second traces having a same area.
